(19) United States
(12) Patent Application Publication
(10) Pub. No.: US 2026/0162337 A1
(43) Pub. Date: Jun. 11, 2026

(54) CONTENT INTERACTION

(71) Applicant: Beijing Zitiao Network Technology Co., Ltd., Beijing (CN)

(72) Inventors: Jiahui YANG, Beijing (CN); Nuomeng ZHANG, Beijing (CN); Jiayi XU, Beijing (CN)

(21) Appl. No.: 19/414,177

(22) Filed: Dec. 9, 2025

(30) Foreign Application Priority Data
Dec. 10, 2024 (WO) PCT/CN2024/138284

(51) Int. Cl. G06T 11/60

(52) U.S. Cl. CPC G06T 11/60; G06T 2200/24; G06T 2219/024

(57) ABSTRACT

Embodiment of the disclosure relates to a method, apparatus, device and storage medium for content interaction. The method provided herein includes: obtaining a first image associated with a first user; and adding, in first media content associated with a second user, a first foreground element associated with the first image, the first foreground element including at least a part of the first image, a first background image of the first media content being determined based on a posting operation of the second user. In this way, embodiments of the present disclosure are capable of supporting co-creation of media content by multiple users.

### CROSS-REFERENCE

This application claims priority to International Patent Application No. PCT/CN2024/138284, filed on Dec. 10, 2024, and entitled “method, apparatus, device, and storage medium for content interaction”, the disclosure of which is incorporated herein by reference in its entirety.

### FIELD

Example embodiments of the present disclosure generally relate to the field of computers, and in particular, to content interaction.

### BACKGROUND

With the popularization of computer technology, the Internet has become an important platform for people's daily communication. For example, a user may post various types of work, such as video work, image work, and the like, on an Internet platform. Conventionally, users may comment, share, like and the like on works posted by other users.

### SUMMARY

In a first aspect of the present disclosure, a content interaction method is provided. The method includes: obtaining a first image associated with a first user; and adding, in first media content associated with a second user, a first foreground element associated with the first image, the first foreground element including at least a part of the first image, a first background image of the first media content being determined based on a posting operation of the second user.

In a second aspect of the present disclosure, an apparatus for content interaction is provided. The apparatus includes: an obtaining module configured to obtain a first image associated with a first user; and an adding module configured to add, in first media content associated with a second user, a first foreground element associated with the first image, the first foreground element including at least a part of the first image, a first background image of the first media content being determined based on a posting operation of the second user.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program thereon, and the computer program is executable by a processor to implement the method of the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments according to the present disclosure may be implemented;

FIGS. 2A-2M illustrate example interfaces in accordance with some embodiments of the present disclosure;

FIG. 3 shows a flowchart of an example process for content interaction according to some embodiments of the present disclosure;

FIG. 4 illustrates a schematic structural block diagram of an example apparatus for content interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

Embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

In the technical solution in this description and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned above, media works have become an important medium for people's network interaction. Conventional media works often have only one creator. Some platforms, while supporting user co-creation, are relatively limited in types of the co-created works. For example, two users may post a co-creation video work, with different users'image content being populated to different parts of the video work. However, after such a co-creation work is posted, other users cannot continue to co-create, which greatly affects the richness of the content.

Embodiments of the present disclosure provide a solution for content interaction. The solution includes: obtaining a first image associated with a first user; and adding, in first media content associated with a second user, a first foreground element associated with the first image, the first foreground element including at least a part of the first image, a first background image of the first media content being determined based on a posting operation of the second user.

In this way, embodiments of the present disclosure can support users to co-create works by adding foreground elements, thereby improving the richness of media content. Therefore, embodiment of the invention supports creation of multiple users, and can simultaneously display contribution parts of multiple users in the same media content, so that the display information of the media content is enriched, and the information obtaining efficiency is improved.

Various example implementations of this solution are described in further detail below with reference to the accompanying drawings.

### Example Environment

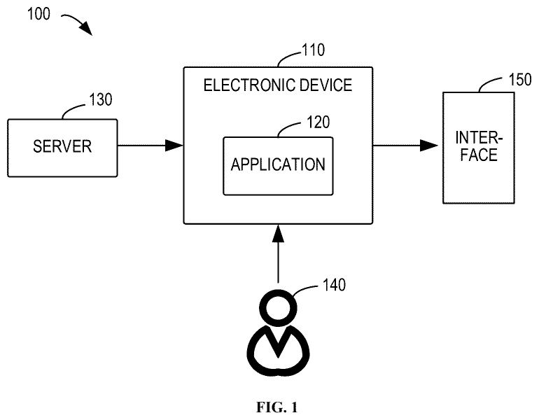

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports content interaction. The application 120 may be any suitable type of application for content interaction, examples of which may include, but are not limited to, social applications, shopping applications, content sharing applications, video playing applications, or other suitable applications. The user 140 may interact with the application 120 via the electronic device 110 and/or its attached device.

In the environment 100 of FIG. 1, if the application 120 is in an active state, the electronic device 110 may present an interface 150 for supporting content interaction through the application 120.

In some embodiments, the electronic device 110 communicates with a server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be a standalone physical server, a server cluster distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support virtual scenarios.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interaction

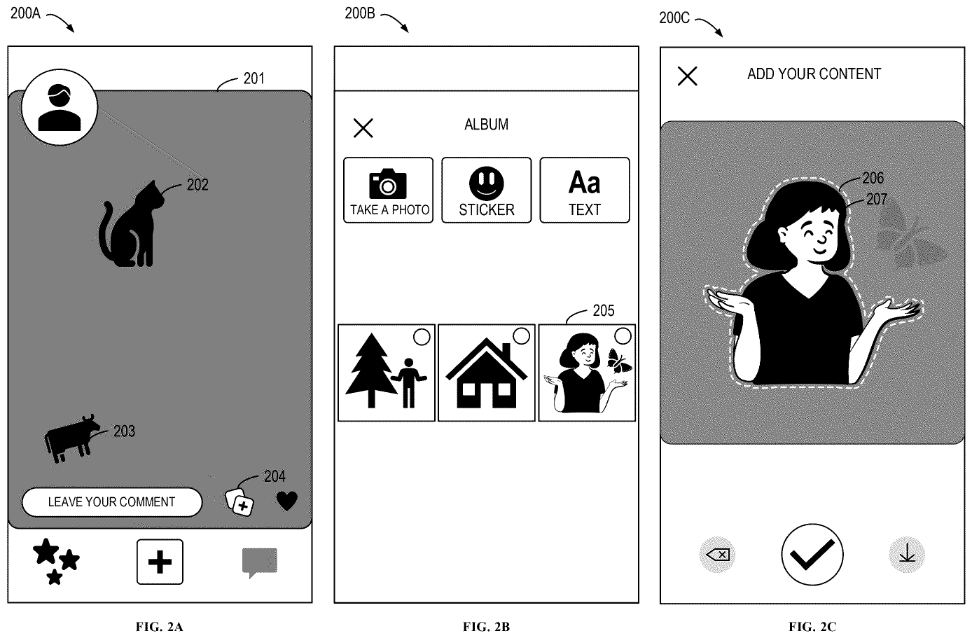

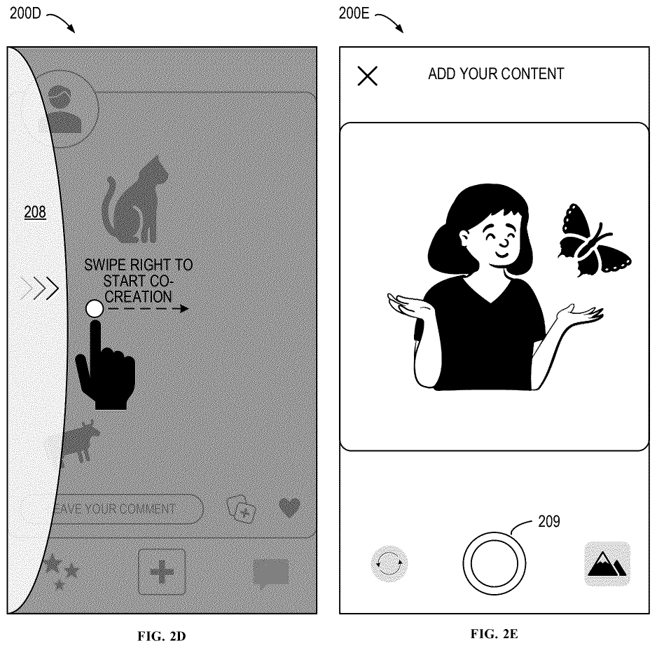

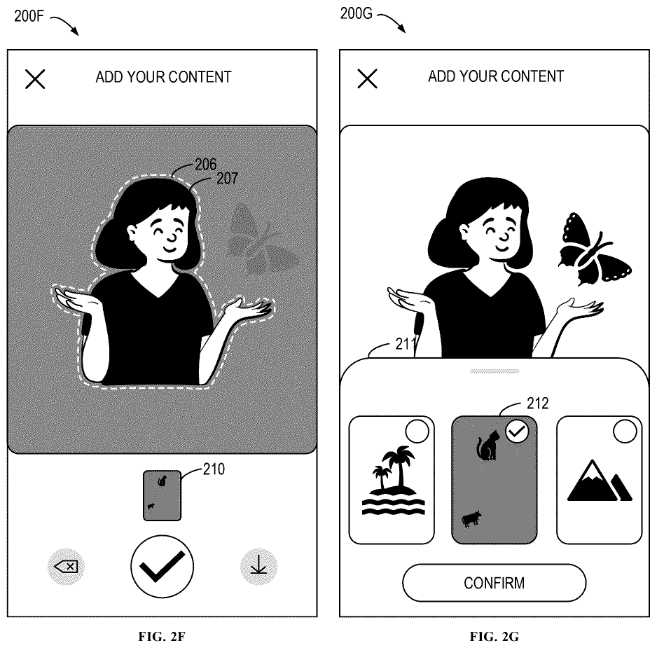

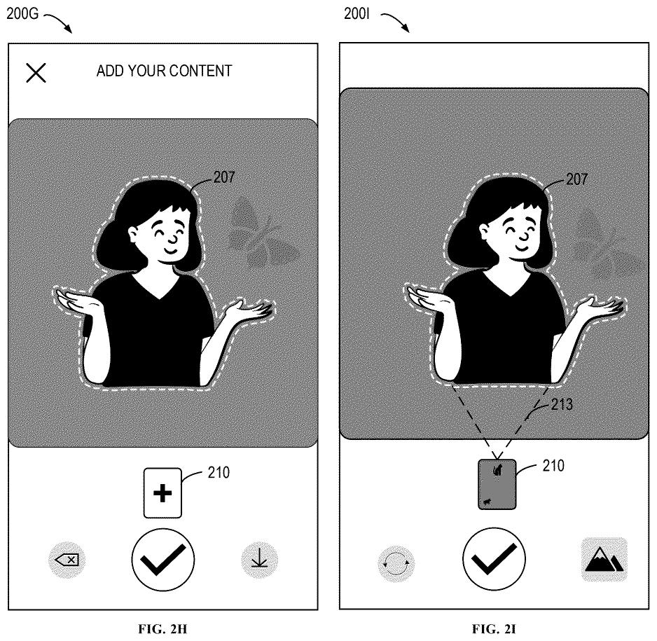

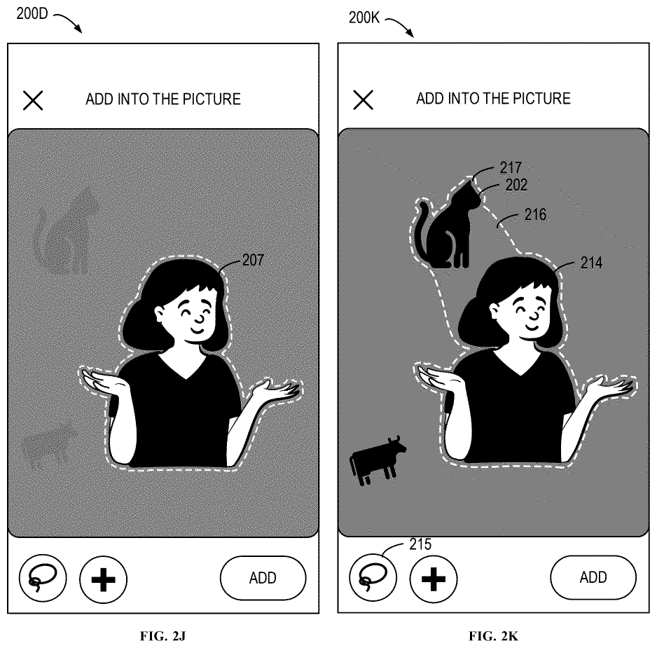

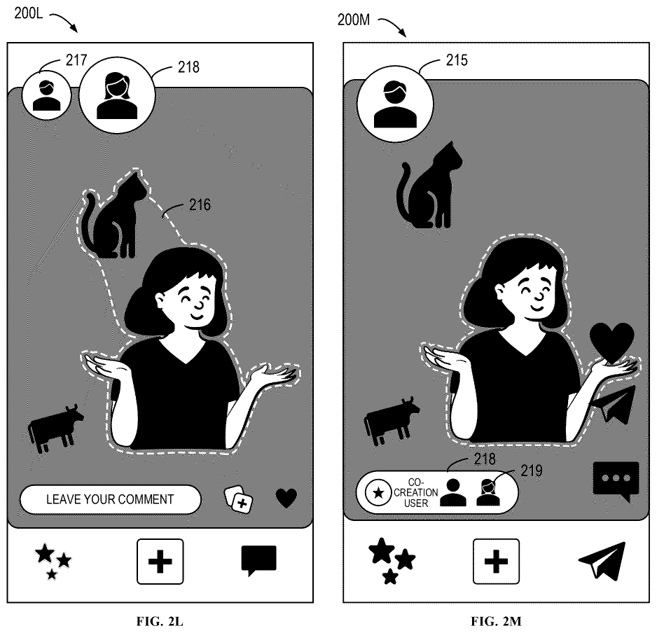

FIGS. 2A-2M illustrate example interfaces 200A to 200M, in accordance with some embodiments of the present disclosure. The interfaces 200A to 200M may be provided, for example, by the electronic device 110 shown in FIG. 1.

In some embodiments, the electronic device 110 may present the interface 200A as shown in FIG. 2A to a first user. The interface 200A may be used to present a media content stream, which may include a plurality of media content posted by a plurality of users of the current application platform. The electronic device 110 may implement switching between the plurality of media content in the media content stream based on the received content switching operation, such as an up-slide operation. The electronic device 110 may also receive an interactive operation of any user on the media content, such as a like operation, a comment operation, an editing operation, or a sharing operation, and the like.

In some embodiments, the electronic device 110 obtains a first image associated with the first user. As an example, such first image may be an image or video content selected by the first user in the album, or may be an image or video content captured by the first user through the electronic device 110.

### Example One

In some embodiments, the electronic device 110 may first present a viewing interface of first media content to be co-created, and then enter a first image obtaining interface through a first entry in the viewing interface of the first media content. Further, after obtaining the first image via the first image obtaining interface, the electronic device 110 may co-create the first media content based on the first image. The co-creating may indicate that a partial region in the first image is added to the first media content.

Specifically, the electronic device 110 may present a viewing interface of the first media content, and the viewing interface includes a first entry. As an example, as shown in FIG. 2A, the first media content may be displayed in a media content stream, and the interface 200A may be, for example, a viewing interface of the first media content. The interface 200A may present the first media content. The first media content may include a first background image 201 and one or more foreground elements, e.g., elements 202 and 203, overlaid on the first background image 201.

In some embodiments, the first media content may be a work posted by the second user. For example, the background image 201 may be a pure color background or a background including a pattern. Additionally, the background image 201 may be automatically determined based on the media content selected by the second user. The electronic device 110 may present the first entry 204 at the interface 200A.

Further, the electronic device 110 may present the first image obtaining interface in response to selection of the first entry. Finally, the electronic device 110 may obtain the first image associated with the first user via the first obtaining interface. As an example, as shown in FIG. 2B, the first image obtaining interface may be, for example, the interface 200B shown in FIG. 2B. The electronic device 110 may present a plurality of preview components, such as the preview component 205, in the interface 200B, the preview component 205 being associated with the first image. After the preview component 205 is selected, the electronic device 110 may obtain the first image associated with the preview component 205.

In some embodiments, the electronic device 110 may further generate a sticker (i.e., a foreground element) by using the first image. Specifically, the electronic device 110 may receive a selection of the preview component 205 by the first user, and present the interface 200C shown in FIG. 2C. The interface 200C may be, for example, an image editing interface of the first image.

Further, the electronic device 110 may receive, in the interface 200C, a selection of an image part 206 in the first image by the first user, so as to present the image part 206 of the first image in the target style. As an example, as shown in FIG. 2C, the electronic device 110 may present a first contour element around the image part 206. The first contour element may be implemented as a dashed line, a solid line, or other suitable style. Still further, the electronic device 110 may determine a first foreground element (i.e., a sticker 207) associated with the first image based on the image part 206.

After obtaining the sticker 207, the electronic device 110 may co-create the first media content based on the obtained sticker 207.

### Example Two

In some embodiments, the electronic device 110 may first obtain the first image through a shooting operation, and then select the media content to be co-created.

As an example, the electronic device 110 may present an interface 200D as shown in FIG. 2D. The media content presented in the interface 200D may be the first media content or other media content. The electronic device 110 may present a first indication element 208 in the interface 200D. The first indication element 208 is used to indicate a gesture for presenting the second image obtaining interface. Such a gesture may be, for example, a sliding operation (e.g., right sliding) of the user to the interface 200D.

Further, the electronic device 110 may receive a right-sliding operation of the first user in the interface 200D, and present the interface 200E shown in FIG. 2E. The interface 200E may be a shooting interface (that is, a second image obtaining interface) of the media content. In this way, embodiments of the present disclosure can quickly present the second image obtaining interface through the sliding operation of the user, thereby improving the efficiency of the media content creation.

In some embodiments, the electronic device 110 may obtain the first image associated with the first user via the second image obtaining interface. As an example, after the first user selects the shooting control 209, the electronic device 110 may perform a shooting operation to obtain the shot first image. After obtaining the first image, the electronic device 110 may present the first image in the interface 200F in FIG. 2F, and determine the sticker 207 by the selection of the image part 206 by the first user.

In some embodiments, after the electronic device 110 obtains the first image by shooting, the first user may further select the to-be-co-created media content through the electronic device 110. The media content to be co-created may be media content posted today by a second user or other user. In some scenarios, the media content to be co-created may be referred to as a drawing board.

Specifically, the electronic device 110 may present, in response to a set of candidate media content associated with a set of users being obtained, the set of candidate media contents in the selection control. The set of candidate media contents may include at least one piece of media content posted by the set of users within a preset time period, where an association relationship between the set of users and the first user satisfies a preset condition. The set of users includes the first user, or the second user is the first user.

As an example, after the first image is obtained, the electronic device 110 may present an interface 200E as shown in FIG. 2E, and the interface 200E includes a control 210. After the first user selects the control 210, the electronic device 110 may present a selection control 211 as shown in FIG. 2F. When the first user or friends of the first user have posted the drawing board today, the electronic device 110 may present the plurality of posted drawing boards in the selection control 211.

Further, the electronic device 110 may determine the first media content based on the selection of the first media content in the selection control. As an example, as shown in FIG. 2F, the electronic device 110 may receive a selection of the drawing board 212 in the selection control 210 by the first user to determine to co-create the drawing board 212. After the drawing board 212 is selected, the electronic device 110 may present a preview image corresponding to the drawing board 212 in the component 210.

In some embodiments, when the friends of the first user and the first user do not post the drawing board today, the first user may post a new drawing board through the electronic device 110. Specifically, the electronic device 110 may create new media content based on the first image in response to no candidate media content being obtained. The new media content includes at least one foreground element overlaid on the second background image, the at least one foreground element being determined based on the first image.

As an example, when the friends of the first user and the first user do not post the drawing board today, the electronic device 110 may present a component 210 in the style shown in FIG. 2F. After the first user selects the component 210, the electronic device 110 may generate the sticker 207 based on the image part 206 in the first image selected by the first user. Further, the electronic device 110 may further obtain a second background image selected by the first user. After both the sticker 207 and the second background image are determined, the electronic device 110 may generate a new drawing board based on the target sticker and the second background image.

After the first image is obtained and the drawing board is also determined or generated, the electronic device 110 may present an interface 200I as shown in FIG. 2I. The interface 200I includes a second indication element 214 indicating that the sticker 207 is added to the artboard 212 shown in the component 210.

The process of the electronic device 110 adding the first image to the first media content will be described below.

In some embodiments, the electronic device 110 may add a first foreground element associated with the first image in the first media content associated with the second user. The first foreground element includes at least a portion of the first image. The first background image of the first media content is determined based on a posting operation of the second user.

As an example, as shown in FIG. 2J, the electronic device 110 may present an interface 200J, which may be an editing interface of the first media content. The interface 200J includes the sticker 207 (i.e., a first foreground element) associated with the first image. The electronic device 110 may add the sticker 207 to the first media content to complete co-creating of the first media content.

In some embodiments, the electronic device 110 may add different parts in the first image to the first media content. Specifically, the electronic device 110 may add a plurality of foreground elements associated with the first image in the first media content associated with the second user. The plurality of foreground elements includes the first foreground element, and the plurality of foreground elements correspond to different parts of the first image.

As an example, as shown in FIG. 2C, the electronic device 110 may receive a related operation (e.g., selection, frame selection, scribing, etc.) of the first image in the interface 200C by the first user, and intercept the plurality of image regions in the first image. Such an image region may be, for example, an image region corresponding to a “person” or an image region corresponding to “butterfly”. After obtaining the plurality of image regions, the electronic device 110 may convert the plurality of image regions into a plurality of stickers to add the plurality of stickers to the first media content.

In some embodiments, the image part added to the first media content includes: a first image part and a second image part. The first image part includes a first image part determined from the reference first media content based on a first editing operation of the user. The first editing operation indicates a first region to be segmented. The second image part is determined by dividing a second region corresponding to a preset object in the reference first media content.

As an example, as shown in FIG. 2K, the electronic device 110 may determine a first region 214 corresponding to the sticker 207 in the reference first media content based on a first editing operation (e.g., a scribing, a box selection, etc.) of the user on the reference first media content. Further, the electronic device 110 may provide an adjustment control 215 in the interface 200K. The electronic device 110 may receive a second editing operation of the user via the adjustment control 215 to adjust the first region 214. For example, before the second editing operation is received, the region corresponding to a sticker 216 only includes the first region 214. After receiving the adjustment operation, the sticker 216 further includes a second image part 217 (for example, an image region corresponding to the foreground element 202).

In some embodiments, after determining the sticker 216 to be added to the first media content, the electronic device 110 may further adjust the display attribute of the sticker in the first media content based on the adjustment operation of the first user. The display attribute includes a display position of the first foreground element, a display size of the first foreground element, a display direction of the first foreground element, and a display hierarchy of the first foreground element.

As an example, the adjustment operation may be, for example, adjusting a display position, a size, or a hierarchy of the first foreground element in the first media content. In this way, the content quality of the first media content can be improved, and the presentation effect of the first media content can be optimized.

In some embodiments, the display attribute may be determined by the electronic device 110 or the server 130 based on reference information. The reference information includes a first set of attributes, a second set of attributes, and template information associated with the first media content. The first set of attributes is associated with a first background image in the first media content. The second set of attributes is associated with at least one sticker (i.e., foreground element) in the first media content.

In some embodiments, when the sticker 216 is added to the first media content, the electronic device 110 further needs to determine whether the sticker 216 satisfies a preset display constraint, and the display constraint at least indicates an occlusion relationship between display elements in the first media content. As an example, the display constraint may be, for example, that the display hierarchy of the sticker 216 needs to be higher than the display hierarchy of the first background image 201. The display style may also be that the sticker 216 cannot be occluded with the sticker 203 each other.

In some embodiments, after the sticker 216 is added to the first media content, the electronic device 110 may display a user identifier of the second user in the first style in the viewing interface of the first media content. Further, the electronic device 110 may display the user identifier of the at least one user in the second style in the viewing interface of the first media content. At least one user is associated with a foreground element added to the first media content. The at least one user includes a first user, and the first style is different from the second style.

As an example, as shown in FIG. 2L, the electronic device 110 may present a user identifier 217 of the second user and a user identifier 218 of the first user in the interface 200L. The user identifier 217 may be presented in a first style and the user identifier 218 may be presented in a second style. For example, the second style may have a different display size, display position, or the like than the first style.

In some scenarios, as shown in FIG. 2M, the user identifier 217 and a viewing component 218 of the second user are included in FIG. 2M. The electronic device 110 may present, in the viewing component 218, a plurality of user identifiers of a user co-creating the first media content, such as a user identifier 219 associated with the first user.

In some embodiments, the electronic device 110 may display, in response to a selection of a target user identifier associated with a target user, a target foreground element associated with the target user distinctively in the viewing interface. As an example, the target user is, for example, the first user, and a sticker associated with the first user is the sticker 216. As shown in FIG. 2L, after the user identifier 218 is selected, the electronic device 110 may highlight the first foreground element 216 associated with the first user. The highlighting may, for example, be enlarged display, highlighting, or any suitable style such as presenting a contour element around the sticker 216.

In some embodiments, the electronic device 110 may present a contour element indicating a boundary of the target foreground element. Such a contour element may, for example, be implemented as any suitable contour element such as a solid line, a dashed line, a bold solid line, or the like. In this way, embodiments of the present disclosure can more conveniently obtain the creator of the foreground element, thereby improving the efficiency of obtaining information.

In some embodiments, the viewing interface is a first viewing interface that presents an interface element associated with the second media content. The electronic device 110 may present a second viewing interface of the second media content in response to a preset operation received at the first viewing interface.

As an example, as shown in FIG. 2A, the interface 200A may be a viewing interface of the first media content. The first media content is presented in a media content stream. After receiving the preset operation of the user in the interface 200A, the electronic device 110 may present the second viewing interface of the second media content. Such a preset operation may be, for example, a sliding operation (e.g., upward sliding or downward sliding) of the user on the interface 200A.

In some embodiments, the electronic device 110 may display a set of foreground elements in a third style in a viewing interface of the first media content, the first set of foreground elements corresponding to the first set of users, and an association relationship between the first set of users and the first user satisfying a preset condition.

As an example, when the relationship between the first set of users corresponding to the first set of foreground elements and the first user satisfies a preset condition (for example, a friend relationship or has been concerned with each other, etc.), the electronic device 110 may present the first set of foreground elements in a color style, to indicate that the first set of users are in a friend relationship with the first user or have followed with each other.

In some embodiments, the electronic device 110 may display the second set of foreground elements in the fourth style in the viewing interface of the first media content. The second set of foreground elements corresponds to the second set of users, and an association relationship between the second set of users and the first user does not satisfy the preset condition. The third style is different from the fourth style.

As an example, when the relationship between the second set of users corresponding to the first set of foreground elements and the first user does not satisfy the preset condition (for example, a non-friend relationship or not following with each other), the electronic device 110 may present the second set of foreground elements in a grayscale style, to indicate that the second set of users and the first user are “strangers” (i.e., non-friend relationships or not following with each other). In this way, embodiments of the present disclosure can make the user more conveniently distinguish whether the multiple foreground elements in the first media content are creations by friends, thereby effectively improving the information obtaining efficiency.

In some embodiments, the electronic device 110 may post the first media content based on a posting operation of the second user. The posting operation of the second user may, for example, indicate whether the first media content is allowed to be added a foreground element, or a range of users being allowed to add a foreground element to the first media content. As an example, the electronic device 110 may obtain the editing permission of the first media content through the posting operation of the second user. Such editing permissions may, for example, indicate whether stickers are allowed to be added, adjusted, or deleted in the first media content. Alternatively, the edit permission may also indicate a user range that allows editing of the first media content. For example, the user range allowed to co-create may include, for example, a friend of the second user and a user following the second user. Alternatively, the user range may also include that all users may participate in co-creation of media content.

In this way, embodiments of the present disclosure can support users to co-create works by adding foreground elements, thereby improving the richness of media content. Therefore, embodiment of the disclosure supports co-creation by multiple users, and can simultaneously display contribution parts of multiple users in the same media content, so that the display information of the media content is enriched, and the information obtaining efficiency is improved.

### Example Process

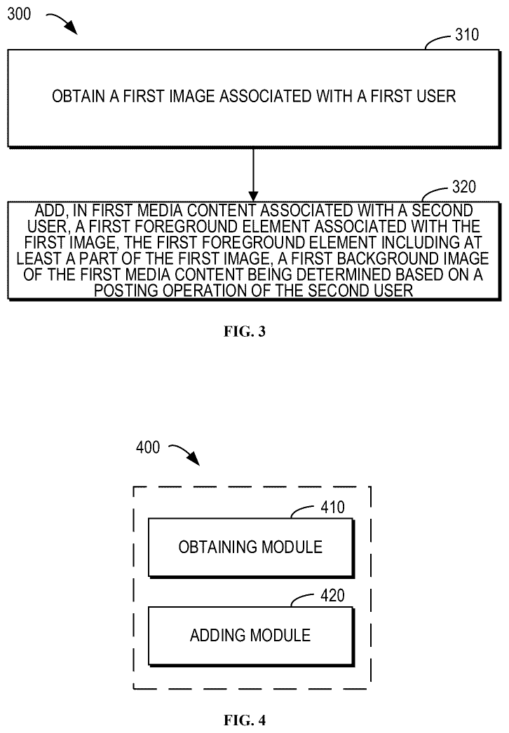

FIG. 3 illustrates a flowchart of an example process 300 of content interaction in accordance with some embodiments of the present disclosure. The process 300 may be implemented at the electronic device 110. The process 300 is described below with reference to FIG. 1.

As shown in FIG. 3, at block 310, the electronic device 110 obtains a first image associated with the first user.

At block 320, the electronic device 110 adds, in first media content associated with a second user, a first foreground element associated with the first image. The first foreground element includes at least a part of the first image. A first background image of the first media content is determined based on a posting operation of the second user.

In some embodiments, the process 300 further includes: presenting an image part of the first image in a target style; and determining the first foreground element associated with the first image based on the image part.

In some embodiments, the image part includes: a first image part determined from reference first media content based on a first editing operation of a user, the first editing operation indicating a first region to be segmented; or a second image part determined by dividing a second region corresponding to a preset object in the reference first media content.

In some embodiments, obtaining the first image associated with the first user includes: presenting a viewing interface of the first media content, the viewing interface comprising a first entry; presenting a first image obtaining interface in response to a selection of the first entry; and obtaining the first image associated with the first user via the first obtaining interface.

In some embodiments, obtaining the first image associated with the first user includes obtaining the first image associated with the first user via the second image obtaining interface.

In some embodiments, the second image obtaining interface includes a selection control, and the process 300 further includes: presenting, in response to a set of candidate media content associated with a set of users being obtained, the set of candidate media content in the selection control; and determining the first media content based on a selection of the first media content in the selection control.

In some embodiments, the set of candidate media content includes at least one piece of media content posted by the set of users within a preset time period, where an association relationship between the set of users and the first user satisfies a preset condition.

In some embodiments, the set of users includes the first user, or the second user is the first user.

In some embodiments, the process 300 further includes: creating, in response to no candidate media content being obtained, new media content based on the first image, the new media content comprising at least one foreground element overlaid on a second background image, the at least one foreground element being determined based on the first image.

In some embodiments, the display attribute of the first foreground element in the first media content is determined based on at least one of: a first set of attributes of the first background image in the first media content; a second set of attributes of the at least one foreground element in the first media content; template information associated with the first media content.

In some embodiments, the process 300 further includes: adjusting a display attribute of the first foreground element in the first media content based on a received adjustment operation.

In some embodiments, the display attribute includes at least one of the following: a display position of the first foreground element; a display size of the first foreground element; a display direction of the first foreground element; a display hierarchy of the first foreground element.

In some embodiments, the display attribute of the first foreground element satisfies a preset display constraint, and the display constraint at least indicates an occlusion relationship between foreground elements in the first media content.

In some embodiments, the process 300 further includes: displaying, in a viewing interface of the first media content, a user identifier of the second user in a first style; and displaying, in a viewing interface of the first media content, a user identifier of the at least one user in a second style, the at least one user being associated with a foreground element added to the first media content, the at least one user including the first user, the first style being different from the second style.

In some embodiments, the process 300 further includes displaying, in response to a selection of a target user identifier associated with a target user, a target foreground element associated with the target user distinctively in the viewing interface.

In some embodiments, displaying a target foreground element associated with the target user distinctively includes presenting a contour element indicating a boundary of the target foreground element.

In some embodiments, the viewing interface is a first viewing interface, the first viewing interface presents an interface element associated with the second media content, and the process 300 further includes: in response to a preset operation received in the first viewing interface, presenting a second viewing interface of the second media content.

In some embodiments, the process 300 further includes: displaying a first set of foreground elements in a third style in a viewing interface of the first media content, the first set of foreground elements corresponding to a first set of users, an association relationship between the first set of users and the first user satisfying a preset condition; and displaying a second set of foreground elements in a fourth style in the viewing interface of the first media content, the second set of foreground elements corresponding to a second set of users, an association relationship between the second set of users and the first user dissatisfy a preset condition, the third style being different from the fourth style.

In some embodiments, the posting operation indicates: whether the first media content is allowed to be added a foreground element; or a range of users being allowed to add a foreground element to the first media content.

In some embodiments, adding, in first media content associated with the second user, a first foreground element associated with the first image comprises adding, in the first media content associated with the second user, a plurality of foreground elements associated with the first image, the plurality of foreground elements comprising the first foreground element, and the plurality of foreground elements corresponding to different image parts of the first image.

### Example Apparatus and Device

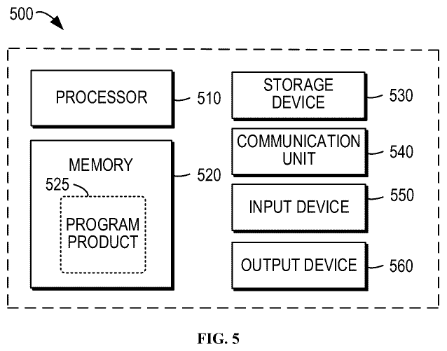

Embodiments of the present disclosure also provide a corresponding apparatus for implementing the above method or process. FIG. 4 shows a schematic structural block diagram of an example apparatus 400 for content interaction according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: an obtaining module 410 configured to obtain a first image associated with a first user; and an adding module 420 configured to add, in first media content associated with a second user, a first foreground element associated with the first image, the first foreground element comprising at least part of the first image, a first background image of the first media content being determined based on a posting operation of the second user.

In some embodiments, the apparatus 400 further includes a first presentation module configured to present an image part of the first image in a target style; and determine the first foreground element associated with the first image based on the image part.

In some embodiments, the image part includes: a first image part determined from reference first media content based on a first editing operation of a user, the first editing operation indicating a first region to be segmented; or a second image part determined by dividing a second region corresponding to a preset object in the reference first media content.

In some embodiments, the obtaining module 410 is further configured to: present a viewing interface of the first media content, the viewing interface comprising a first entry; present a first image obtaining interface in response to a selection of the first entry; and obtain the first image associated with the first user via the first obtaining interface.

In some embodiments, the obtaining module 410 is further configured to obtain the first image associated with the first user via a second image obtaining interface.

In some embodiments, the second image obtaining interface includes a selection control, and the apparatus 400 further includes a second presentation module configured to present, in response to a set of candidate media content associated with a set of users being obtained, the set of candidate media content in the selection control; and determine the first media content based on a selection of the first media content in the selection control.

In some embodiments, the set of candidate media content includes at least one piece of media content posted by a set of users within a preset time period, where an association relationship between the set of users and the first user satisfies a preset condition.

In some embodiments, the set of users includes the first user, or the second user is the first user.

In some embodiments, the apparatus 400 further includes a creating module configured to create, in response to no candidate media content being obtained, new media content based on the first image, the new media content comprising at least one foreground element overlaid on a second background image, the at least one foreground element being determined based on the first image.

In some embodiments, the display attribute of the first foreground element in the first media content is determined based on at least one of: a first set of attributes of the first background image in the first media content; a second set of attributes of the at least one foreground element in the first media content; template information associated with the first media content.

In some embodiments, the apparatus 400 further includes an adjustment module configured to adjust the display attribute of the first foreground element in the first media content based on a received adjustment operation.

In some embodiments, the display attribute includes at least one of the following: a display position of the first foreground element; a display size of the first foreground element; a display direction of the first foreground element; a display hierarchy of the first foreground element.

In some embodiments, the display attribute of the first foreground element satisfies a preset display constraint, and the display constraint at least indicates an occlusion relationship between foreground elements in the first media content.

In some embodiments, the apparatus 400 further includes a first display module configured to display a user identifier of the second user in a first style in a viewing interface of the first media content; and display, in the viewing interface of the first media content, a user identifier of at least one user in a second style, the at least one user being associated with a foreground element added to the first media content, the at least one user comprising the first user, the first style being different from the second style.

In some embodiments, the apparatus 400 further includes a second display module configured to display, in response to a selection of a target user identifier associated with a target user, a target foreground element associated with the target user distinctively in the viewing interface.

In some embodiments, the second display module is further configured to present a contour element indicating a boundary of the target foreground element.

In some embodiments, the viewing interface is a first viewing interface presenting an interface element associated with the second media content, and the apparatus 400 further includes a presentation module configured to present a second viewing interface of the second media content in response to a preset operation received in the first viewing interface.

In some embodiments, the apparatus 400 further includes a third display module configured to display a first set of foreground elements in a third style in a viewing interface of the first media content, the first set of foreground elements corresponding to a first set of users, an association relationship between the first set of users and the first user satisfying a preset condition; and display a second set of foreground elements in a fourth style in the viewing interface of the first media content, the second set of foreground elements corresponding to a second set of users, an association relationship between the second set of users and the first user dissatisfy a preset condition, the third style being different from the fourth style.

In some embodiments, the posting operation indicates: whether the first media content is allowed to be added a foreground element; or a range of users being allowed to add a foreground element to the first media content.

In some embodiments, the adding module 420 is further configured to add, in the first media content associated with the second user, a plurality of foreground elements associated with the first image, the plurality of foreground elements comprising the first foreground element, and the plurality of foreground elements corresponding to different image parts of the first image.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. A method for content interaction, comprising:
obtaining a first image associated with a first user; and
adding, in first media content associated with a second user, a first foreground element associated with the first image, the first foreground element including at least a part of the first image, a first background image of the first media content being determined based on a posting operation of the second user.

2. The method of claim 1, further comprising:
presenting an image part of the first image in a target style; and
determining the first foreground element associated with the first image based on the image part.

3. The method of claim 2, wherein the image part comprises:
a first image part determined from reference first media content based on a first editing operation of a user, the first editing operation indicating a first region to be segmented, or
a second image part determined by dividing a second region corresponding to a preset object in the reference first media content.

4. The method of claim 1, wherein obtaining a first image associated with a first user comprises:
presenting a viewing interface of the first media content, the viewing interface comprising a first entry;
presenting a first image obtaining interface in response to a selection of the first entry; and
obtaining the first image associated with the first user via the first obtaining interface.

5. The method of claim 1, wherein obtaining a first image associated with a first user comprises:
obtaining the first image associated with the first user via a second image obtaining interface.

6. The method of claim 5, wherein the second image obtaining interface comprises a selection control, and the method further comprises:
presenting, in response to a set of candidate media content associated with a set of users being obtained, the set of candidate media content in the selection control; and
determining the first media content based on a selection of the first media content in the selection control.

7. The method of claim 6, wherein the set of candidate media contents comprises: at least one piece of media content posted by the set of users within a preset time period, wherein an association relationship between the set of users and the first user satisfies a preset condition, and/or
wherein the set of users comprises the first user, or the second user is the first user.

8. The method of claim 6, further comprising:
creating, in response to no candidate media content being obtained, new media content based on the first image, the new media content comprising at least one foreground element overlaid on a second background image, the at least one foreground element being determined based on the first image.

9. The method of claim 1, wherein a display attribute of the first foreground element in the first media content is determined based on at least one of:
a first set of attributes of the first background image in the first media content,
a second set of attributes of at least one foreground element in the first media content, or
template information associated with the first media content.

10. The method of claim 9, further comprising:
adjusting the display attribute of the first foreground element in the first media content based on a received adjustment operation.

11. The method of claim 9, wherein the display attribute comprises at least one of: a display position of the first foreground element, a display size of the first foreground element, a display direction of the first foreground element, or a display hierarchy of the first foreground element, and/or
wherein the display attribute of the first foreground element satisfies a preset display constraint, and the display constraint at least indicates an occlusion relationship between foreground elements in the first media content.

12. The method of claim 1, further comprising:
displaying a user identifier of the second user in a first style in a viewing interface of the first media content; and
displaying, in the viewing interface of the first media content, a user identifier of at least one user in a second style, the at least one user being associated with a foreground element added to the first media content, the at least one user comprising the first user, the first style being different from the second style.

13. The method of claim 12, further comprising:
displaying, in response to a selection of a target user identifier associated with a target user, a target foreground element associated with the target user distinctively in the viewing interface.

14. The method of claim 13, wherein displaying a target foreground element associated with the target user distinctively comprises:
presenting a contour element for indicating a boundary of the target foreground element.

15. The method of claim 12, wherein the viewing interface is a first viewing interface presenting an interface element associated with second media content, and the method further comprises:
presenting a second viewing interface of the second media content in response to a preset operation received in the first viewing interface.

16. The method of claim 1, further comprising:
displaying a first set of foreground elements in a third style in a viewing interface of the first media content, the first set of foreground elements corresponding to a first set of users, an association relationship between the first set of users and the first user satisfying a preset condition; and
displaying a second set of foreground elements in a fourth style in the viewing interface of the first media content, the second set of foreground elements corresponding to a second set of users, an association relationship between the second set of users and the first user dissatisfy a preset condition, the third style being different from the fourth style.

17. The method of claim 1, wherein the posting operation indicates:
whether the first media content is allowed to be added a foreground element, or
a range of users being allowed to add a foreground element to the first media content.

18. The method of claim 1, wherein adding, in first media content associated with the second user, a first foreground element associated with the first image comprises:
adding, in the first media content associated with the second user, a plurality of foreground elements associated with the first image, the plurality of foreground elements comprising the first foreground element, and the plurality of foreground elements corresponding to different image parts of the first image.

19. An electronic device comprising:
at least one processor; and
at least one memory coupled to the at least one processor and storing instructions for execution by the at least one processor, the instructions, when executed by the at least one processor, causing the electronic device to:
obtain a first image associated with a first user; and
add, in first media content associated with a second user, a first foreground element associated with the first image, the first foreground element including at least a part of the first image, a first background image of the first media content being determined based on a posting operation of the second user.

20. A non-transitory computer-readable storage medium having stored thereon a computer program executable by a processor to perform acts comprising:
obtaining a first image associated with a first user; and
adding, in first media content associated with a second user, a first foreground element associated with the first image, the first foreground element including at least a part of the first image, a first background image of the first media content being determined based on a posting operation of the second user.
